(19) United States
(12) Patent Application Publication
(10) Pub. No.: US 2022/0264848 A1
(43) Pub. Date: Aug. 25, 2022

(54) Autonomous Interactive Toy Kit for Pets

(71) Applicant: Nancy Grolley, Toms River, NJ (US)

(72) Inventor: Nancy Grolley, Toms River, NJ (US)

(21) Appl. No.: 17/324,177

(22) Filed: May 19, 2021

Related U.S. Application Data
(60) Provisional application No. 63/152,547, filed on Feb. 23, 2021.

(51) Int. Cl. A01K 15/02

(52) U.S. Cl. CPC A01K 15/025

(57) ABSTRACT

This present invention relates to an autonomous interactive toy kit to keep pets entertained, busy and free from boredom and anxiousness. The autonomous interactive toy kit includes a portable pet mobile having a plurality of hooks to hang a plurality of toys, a pet mobile stand configured to hang the pet mobile, a toy component having a toy attached to a line taut between two stands, a wireless speaker configured to connect to an electronic device through a wireless channel, a suction cup attached to a cable having loops to hang toys, and a zip-line to which a pulley zip-line can be attached wherein the pulley zip-line includes one or more toys. The portable pet mobile includes a plurality of ribbons or small leashes at varying lengths, allowing for toys to be connected in reachable and non-reachable positions.

### CROSS-REFERENCE TO RELATED APPLICATION

The present application claims priority to, and the benefit of, U.S. Provisional Application No. 63/152,547, which was filed on Feb. 23, 2021 and is incorporated herein by reference in its entirety.

### FIELD OF THE INVENTION

The present invention relates generally to the field of autonomous interactive toys for pets. More specifically, the present invention relates to an autonomous interactive toy kit comprising a plurality of toys and devices to engage pets left alone at home or to distract them while they are being given medicine, or in other similar situations. The pet toy kit described herein provides for physical and mental stimulation of pets. The autonomous interactive toy kit prevents pets from getting bored or anxious when they are left alone at home, or occupies them when they are at the veterinarian or the groomer. The toy kit can be used to train pets to fetch toys and return them, for hunting and frisbee training and to keep pets entertained while travelling, bathing and more. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, many people domesticate an animal such as a dog, cat or the like, to help them manage their own loneliness and depression. Pets help in reducing the stress of their owners if pets behave and listen properly. However, when pets are left alone at home, especially those in a cage or a crate, they can get incredibly anxious and start to develop separation anxiety from their owners. While suffering with separation anxiety, pets display distress behaviors such as destroying items, destructive chewing, digging and scratching at doors or windows, urination and defecation, howling, barking, whining and more. In the absence of their owners, pets get bored and destroy furniture and other items in the home, causing huge losses to pet owners.

Additionally, pets may easily become anxious while their owners give them medicine or treatments. The agitated behavior of pets while medicating them makes it quite difficult for pet owners to handle their pets. Further, in scenarios, when pets are with a groomer, the groomer may struggle in managing the pets. Usually, pets are required to stay still and patient while the groomer cleans and grooms the pet. However, without a way to distract the pet, pet owners, groomers and others may find it difficult to handle the pets.

Furthermore, while travelling to places, some pets dislike vehicle rides, which often times triggers motion-sickness. This causes still further stress and anxiety among pets. Also, with anxious and motion-sick pets, it may be extremely difficult to drive a vehicle any significant distance. Further, while bathing pets, not all pets like their bath time which may make it difficult for pet owners to wash their pets regularly.

Therefore, there exists a long felt need in the art for a device that keeps pets engaged while the pet owners are away, and therefore prevents the pets from being anxious while they are alone. There is long felt need for a device that can autonomously provide both physical and mental stimulation to pets. There is also a long felt need in the art for an autonomous interactive toy for pets that distracts the pet and prevents pets from suffering separation anxiety. Additionally, there is a long felt need in the art for an autonomous interactive toy for distracting pets while grooming them. Moreover, there is a long felt need in the art for a pet-distracting means that can be used to entertain pets while giving them medicines. Further, there is a long felt need in the art for an autonomous interactive toy that distracts pets while travelling to places, and prevents them from suffering from motion-sickness. Furthermore, there is a long felt need in the art for an autonomous interactive toy that keeps pets distracted during their bath-time. There is a long felt need in the art for an autonomous interactive toy that allows pet owners, groomers and other people to easily handle pets. Finally, there is a long felt need in the art for an autonomous interactive toy kit that prevents pets from getting anxious or bored when left home alone, while at the groomer, during travel and more.

The subject matter disclosed and claimed herein, in one embodiment thereof, comprises an autonomous interactive toy kit to keep pets entertained and busy, thereby providing mental and physical stimulation. The toy kit comprises: a portable pet mobile having a plurality of hooks to hang a plurality of toys; a pet mobile stand configured to hang the pet mobile; a Kong® toy component having a Kong® toy including peanut butter attached to a line or rope between two stands; a wireless speaker configured to connect to an electronic device through a wireless channel; a suction cup attached to a cable having loops to hang toys; and, a zip-line to which a pulley zip-line can be attached wherein the pulley zip-line includes one or more toys. The pet mobile stand is extendable in a vertical direction and includes a weighted base. The wireless speaker can emit music/audio played on a paired electronic device. The portable pet mobile includes a plurality of ribbons or small leashes of varying lengths, allowing for toys to be connected in reachable and non-reachable positions.

In this manner, the novel autonomous interactive toy kit of the present invention accomplishes all of the forgoing objectives, and provides a relatively efficient and convenient solution to engage and distract pets while pets are home alone, with the groomer, while travelling, bathing or in other scenarios. The autonomous interactive toy kit of the present invention can also be used to train pets while ensuring the safety of pets. Additionally, the autonomous interactive toy kit provides a convenient means for pet owners, groomers or other individuals to handle anxious pets.

### SUMMARY OFS THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an autonomous interactive toy kit to keep pets entertained and busy, thereby providing mental and physical stimulation. The toy kit comprises: a portable pet mobile having a plurality of hooks to hang a plurality of toys; a pet mobile stand configured to hang the pet mobile; a Kong® toy component having a Kong® toy including peanut butter attached to a line or rope between two stands; a wireless speaker configured to connect to an electronic device through a wireless channel; a suction cup attached to a cable having loops to hang toys; and, a zip-line to which a pulley zip-line can be attached wherein the pulley zip-line includes one or more toys. The pet mobile stand is extendable in a vertical direction and includes a weighted base. The wireless speaker can emit music/audio played on a paired electronic device. The portable pet mobile includes a plurality of ribbons or small leashes of varying lengths, allowing for toys to be connected in reachable

In a further embodiment of the present invention, a portable and hanging pet mobile for hanging toys is disclosed. The pet mobile comprises: a circular plate having a clip on an upper surface; a plurality of clips on a lower surface; the upper surface clip engages to a hook to hang the circular plate; a plurality of ribbons or small leashes of different lengths designed to be hung on the hooks of the lower surface; and, each ribbon includes an attached toy with which a pet can play and entertain itself. The portable pet mobile includes a plurality of ribbons or small leashes of varying lengths, allowing for toys to be connected in reachable and non-reachable positions.

The present invention can be marketed as a complete kit or individual components of the kit can be purchased individually as well. The kit provides a complete entertainment package for a pet. The hanging mobile can be connected to a crate or cage ceiling. The standing mobile can feature a weighted base or suction cups on the base to keep the mobile stable. Toys and accessories can be attached to the ribbons or small leashes for the pet to play with. There can be a Bluetooth speaker that can be attached to the cage/crate. Furthermore, there can be a sturdy stand(s) for a Kong® toy to hang therebetween. The Kong® can include peanut butter or other food items in its interior. The stands can be available in bigger or more sturdy versions for larger dogs. There can also be a ribbon or stronger hanger to further accommodate larger dogs. All versions of the pet mobile help keep pets distracted while home alone, at a groomer and more. The kit and its components prevent a pet from getting bored or anxious when left home alone, while at the groomer and more.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a toy mobile stand and a pet mobile with ribbons or small leashes and hook components of a toy kit of the present invention in accordance with the disclosed architecture;

FIG. 2 is a perspective view of the pet mobile of the present invention for hanging multiple types of pet toys as per the disclosed architecture;

FIG. 3 illustrates a perspective view of the pet mobile hung from the top surface of a crate or cage of a pet in accordance with the disclosed architecture;

FIG. 4 illustrates a perspective view of the Kong® toy component of the autonomous interactive toy kit of the present invention in accordance with the disclosed architecture;

FIG. 5 illustrates a perspective view showing the wireless connection between a wireless speaker of the toy kit of the present invention with an electronic device in accordance with the disclosed architecture;

FIG. 6 illustrates a perspective view showing use of zip-line and pulley zip-line components of the autonomous interactive toy kit of the present invention in accordance with the disclosed architecture; and

FIG. 7 illustrates a suction cup connected to a cable for hanging pet toys to keep a pet entertained in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there exists a long felt need in the art for a device which keeps pets engaged while pet owners are away, and therefore prevents the pets from becoming anxious while they are alone. There is long felt need for a device that can autonomously provide physical and mental stimulation to pets. There is also a long felt need in the art for an autonomous interactive toy for pets that distracts the pet and prevents the pet from suffering separation anxiety. Additionally, there is a long felt need in the art for an autonomous interactive toy for distracting pets while grooming them. Moreover, there is a long felt need in the art for a pet-distracting means that can be used to distract pets while giving them medicines. Further, there is a long felt need in the art for an autonomous interactive toy that distracts pets while travelling to places, and prevents them from motion-sickness. Furthermore, there is a long felt need in the art for an autonomous interactive toy that keeps pets distracted during their bath-time. There is a long felt need in the art for an autonomous interactive toy that allows the pet owners, groomers and other people to easily handle their pets. Finally, there is a long felt need in the art for an autonomous interactive toy kit that prevents pets from getting anxious or bored when left home alone, while at a groomer, travelling and more.

The present invention, in one exemplary embodiment, is a novel autonomous interactive toy kit to keep pets entertained and busy while providing mental and physical stimulation to the pets. The autonomous toy kit comprises: a portable pet mobile having a plurality of hooks to hang a plurality of toys; a pet mobile stand configured to hang the pet mobile; a Kong® toy component having a Kong® toy including, for example, peanut butter therein attached to a line between two stands; a wireless speaker configured to connect to an electronic device through a wireless channel; a suction cup attached to a cable having loops to hang toys; and, a zip-line to which a pulley zip-line can be attached, wherein the pulley zip-line includes one or more toys. The pet mobile stand can be extendable in a vertical direction and includes a weighted base. The wireless speaker can emit music/audio played on a paired electronic device. The portable pet mobile includes a plurality of ribbons or small leashes of varying lengths, allowing for toys to be connected in reachable and non-reachable positions.

Referring now to the drawings, the FIGURES illustrate a perspective view of a pet mobile kit of the present invention in accordance with the disclosed architecture. The pet mobile kit 100 includes a collection of toys for pets which are designed for pets such as dogs, cats or any other pet. The pet mobile kit 100 can comprise a toy stand 102, a toy mobile 103, a Kong® stand 104, a Bluetooth speaker 106, a suction cup 108 and a zip-line 110. The pet mobile kit 100 can have additional toys and components as well. The toys and other means of playing with the toy kit 100 are mentally and physically stimulating and assist in fulfilling a pet's emotional and physical needs. The pet mobile kit 100 encourages active play, which provides excellent mental stimulation and minimizes periods of boredom for the pet. The sturdy toy stand 102 enables a pet to play with the toys hanging on a pet mobile 103. The multipurpose circular pet toy hanging device 103 comes in the kit 100, and can be used to hang toys such as plastic dog bone chew toy, or a stuffed animal toy, or any other such type of toy.

The Kong® toy 104 is designed for the growing teeth and jaws of a pet. The Kong® toy 104 helps to promote the entry of growing teeth, while establishing healthy chewing habits. The Kong® toy 104 can be designed in the form of multiple balls which are pushed together. The Kong® toy 104 can be made of rubber and can be hollow on the inside. The Kong® toy 104 can be stuffed with treats, peanut butter or frozen pet food to provide a longer distraction time for pets. The pet mobile kit 100 can include a Bluetooth speaker 106 that may be attached to a pet cage to play music. The Bluetooth speaker 106 can be connected to a nearby electronic device such as a mobile phone, a computer, a laptop or any other electronic device to play the music. The music can help pets such as a dog or cat relieve their stress.

The pet mobile kit 100 includes a suction cup 108 which is designed to attach waterproof toys and can be used in a sink or bathtub to keep the pet entertained while getting bathed. The suction cup 108 with the connected pull toys provides an autonomous interactive and entertaining distraction for the pet. The suction cup 108 gives adequate resistance for the pet to pull on and the tugging helps motion to increase the pet's impulse control. The suction cup 108 can be beneficial for the physical health of the pet. The pet mobile kit 100 can also include a zip-line 110, which can be designed for outdoor places especially in parks, beaches, forests, camping areas and other outdoor places. A pulley runner line can be attached to the zip-line 110 to train pets to fetch and return toys or objects to the pet owners or users. All the components and toys of the toy kit 100 are safe for all types of pets and also for toddlers. The toy kit 100 prevents a pet from getting bored or anxious when left home alone, while at the groomer, and more.

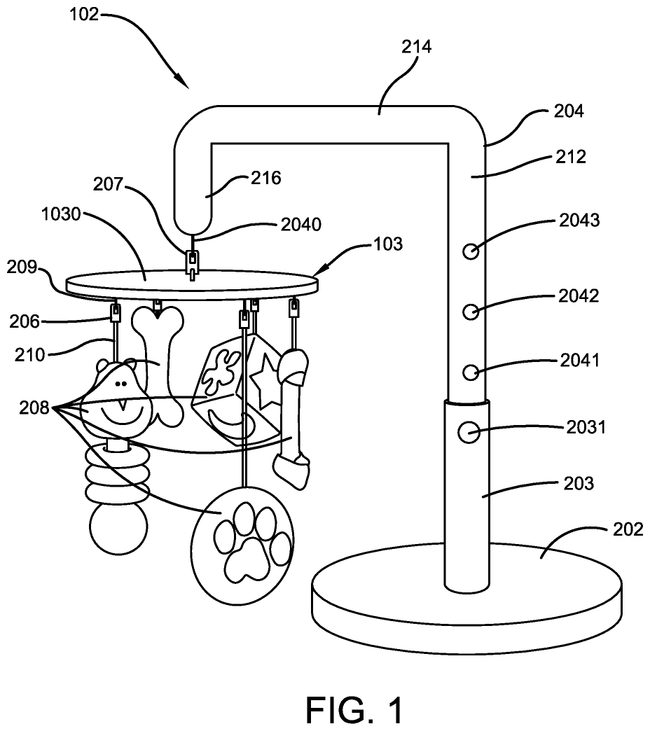

FIG. 1 illustrates a perspective view of a toy mobile stand and the pet mobile with ribbons or small leashes and hook components of the toy kit of the present invention in accordance with the disclosed architecture. The mobile stand 102 is a sturdy stand made up of plastic or lightweight metal. The stand 102 comprises a weighted stabilized base 202 having an extended vertical sleeve 203 extending from the center of the stabilized base 202. A substantially rectangular U-shaped portion arm or pillar 204 includes a longer vertical portion 212, a horizontal portion 214 extending radially from the longer vertical portion 212 and a smaller vertical portion 216 extending downward from the horizontal portion 214. A plurality of engaging holes 2041, 2042, 2043 are present on the longer vertical portion 212 and engage with the vertical sleeve 203. The engagement mechanism can include a screw 2031 for mating with one of the plurality of engaging holes 2041, 2042, 2043 to vertically lengthen or shorten the height of the mobile stand 102. The base 202 includes a weight preventing the mobile stand 102 from tilting or falling when a pet is playing with the toys hung on the stand 102.

At the end of the smaller vertical portion 216, a hook 2040 is present and used for hanging a pet mobile 103. The pet mobile 103 is circular in shape having a circular plate 1030 which includes a mobile swivel clip 207 on its upper surface. The mobile swivel clip 207 is attached on the hook 2040 for hanging the pet mobile 103. The pet mobile 103 is used for hanging a plurality of toys through a plurality of ribbons or small leashes 210. The ribbons or small leashes 210 may be of different lengths, and each ribbon 210 is hung using corresponding ribbon or leash clips 206. The bottom surface of the circular plate 1030 includes a plurality of hooks 209 on which the leash clips 206 are engaged. Each ribbon 210 includes an integrated toy 208 with which a pet can play. It is to be appreciated that the lengths of the small leashes 210 can be of different lengths in order to place the toys 208 at different levels of access to a pet positioned below the toys 208.

The toys 208 are included in the toy kit 100 of the present invention and can be customized for different stages of the life of a pet, such as the puppy stage, adult stage and senior stage. The toys 208 may have special materials that are appropriate for different ages or can target an age-related issue. Toys 208 vary from softer and less durable materials to those constructed to withstand power chewers. The toys 208 can play pet sounds such as a grumble, grunt or crackle, or can include recorded noises, such as animal sounds which are emitted when the toy is pressed or squeezed by the pet. Once the toys 208 are hung from the circular plate 1030 of the pet mobile 103, each ribbon 210 can be securely fastened using the leash clips 206 and ribbons or small leashes 210. Once in place, the toys are not easily removed by the pet, thereby ensuring safety of the pet and toddlers.

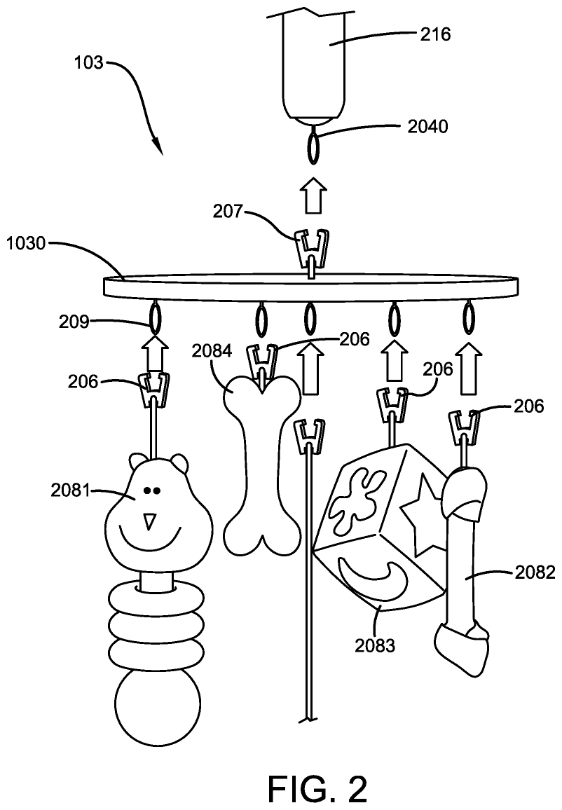

FIG. 2 is a perspective view of the pet mobile of the present invention for hanging multiple types of pet toys as per the disclosed architecture. The pet mobile 103 is configured to be hung on a pole such as small vertical pole 216 having a hook 2040. A mobile swivel 207 connected to the upper surface of a circular plate 1030 is used for hanging by engaging to the hook 2040. A plurality of toys 2081, 2082, 2083, 2084 and more can be hung on the circular plate 1030 through a plurality of ribbons or small leashes 210. The ribbons or small leashes 210 can be of different lengths, and each ribbon 210 can be hung using corresponding ribbon or leash clips 206. The bottom surface of the circular plate 1030 includes a plurality of hooks 209 on which the leash clips 206 are engaged. Each ribbon 210 includes an integrated toy 208 with which a pet can play.

The toys 208 can be of different shapes and sizes and can be customized for different pets. A face-shaped toy 2081, a dumbbell-shaped toy 2082, a cubic toy 2083 and a bone-shaped toy 2084 are shown in the present embodiment (refer to FIG. 2). It should be appreciated that toys of any shape and size can be connected to the ribbons or small leashes 210 and hung from the hooks 209.

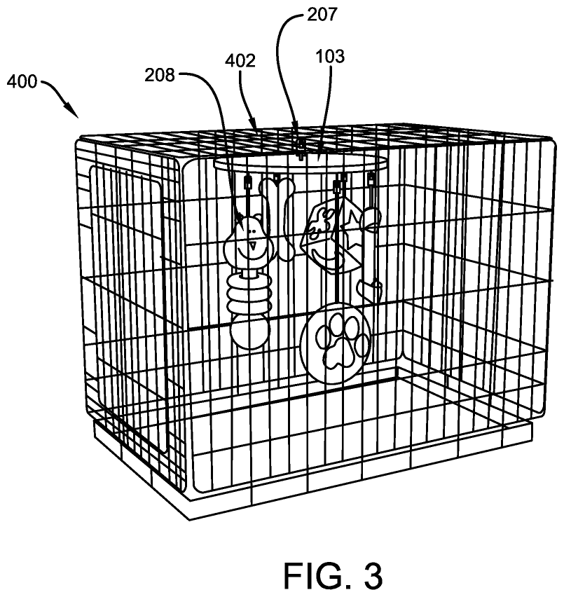

FIG. 3 illustrates a perspective view of the pet mobile hung from the top surface of a crate or cage of a pet in accordance with the disclosed architecture. The pet mobile 103 of the present invention can be hung from a roof 402 of a pet cage 400 using the mobile clip 207. The mobile clip 207 can be engaged around one of the bars or wire frames of the roof 402 to securely hang the pet mobile 103. The toys 208 hung from the pet mobile 103 entertain a pet within the cage 400 and keep the pet entertained and active (i.e. mentally and physically stimulated). The toys are safe for pets and even for toddlers. It should be noted that the length of the ribbons or small leashes can be lengthened or shortened based on the requirements and height of the pet.

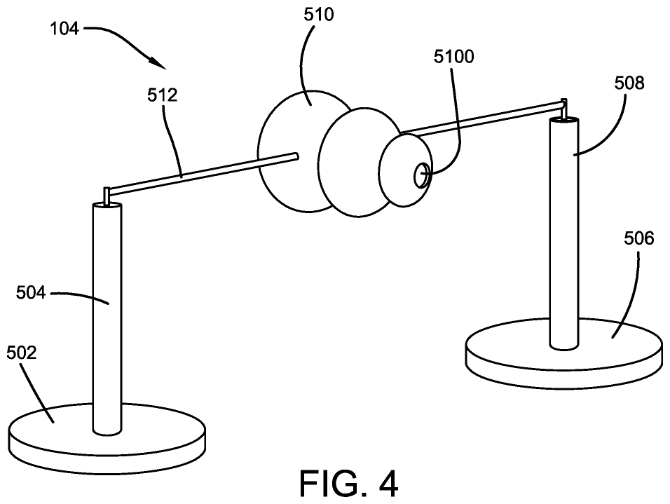

FIG. 4 illustrates a perspective view of the Kong® toy component of the autonomous interactive toy kit of the present invention in accordance with the disclosed architecture. The Kong® toy component 104 includes a pair of stands 504, 508 connected with a rope or string 512, and a Kong® toy 510. The rope or string 512 includes an integrated Kong® toy 510 for entertaining a pet. The Kong® toy 510 remains stable with the use of a weighted base 502 for the stand 504, and the weighted base 506 for the stand 508. The stands 504, 508 can be adjustable in height to accommodate dogs of varying size. The larger the dog, the higher the extension of stands 504, 508, and vice-versa. The length of the line or rope 512 can be extended using rope spools (not illustrated) within the stands 504, 508 so as to increase the gap between the stands.

The Kong® toy 510 includes a teething rubber formula and soft puppy rubber. The Kong® toy 510 is made of unique rubber especially designed for soothing a pet's aching teeth and gums. The Kong® toy 510 can be packed with ziggies, peanut butter and kibbles using an opening 5100. The Kong® toy 510 encourages a pet to play, and offers enrichment while helping prevent behavioral challenges.

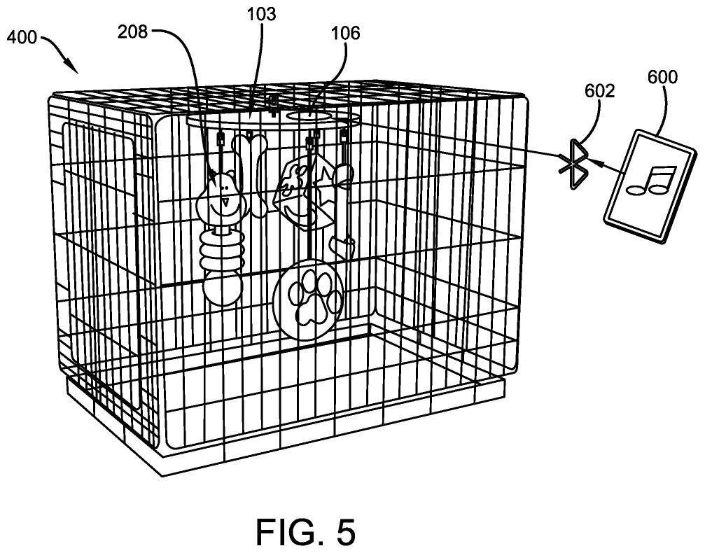

FIG. 5 illustrates a perspective view showing a wireless connection between a wireless speaker of the toy kit of the present invention with an electronic device in accordance with the disclosed architecture. The wireless speaker 106 can be part of the autonomous interactive toy kit 100 of the present invention and can be connected to an electronic device 600 using a wireless connection 602 such as Bluetooth/RFID/Infrared/NFC/Wi-Fi Direct. The songs played on the electronic device 600 can emit from the wireless speaker 106 for entertainment of the pet in the cage 400. While playing with the toys 208 hanging from the pet mobile 103, the pet can enjoy the music from the wireless speaker 106. The wireless speaker 106 can have a clip at the rear portion or may have a magnetic attachment to connect to a metallic surface such as the cage 400. The wireless speaker 106 emits the sound in a decibel level suitable for pets.

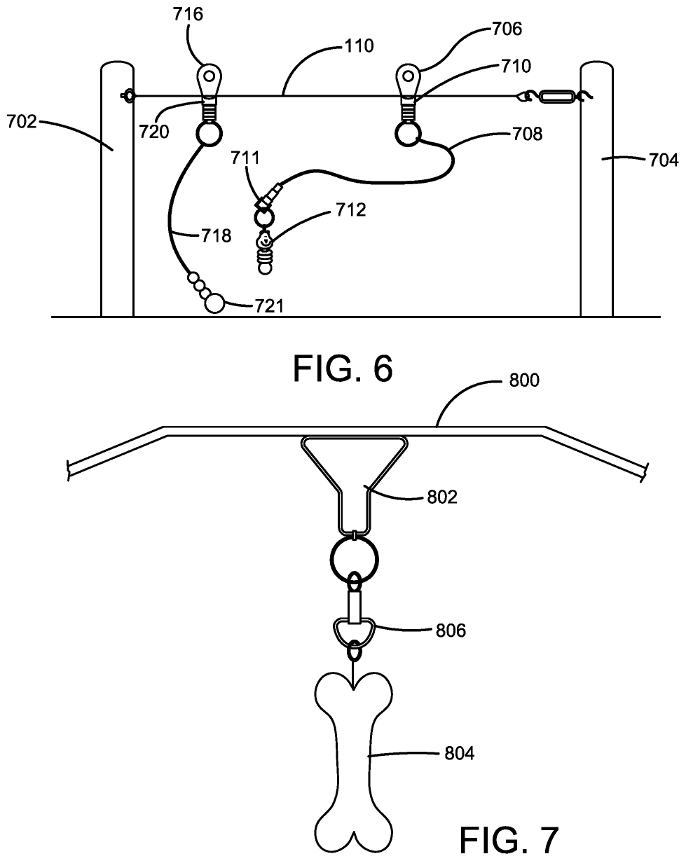

FIG. 6 illustrates a perspective view showing use of zip-line and pulley zip-line components of the autonomous interactive toy kit of the present invention in accordance with the disclosed architecture. A zip-line 110 can be connected between any two vertical stands 702, 704. The stands 702, 704 can be slanted or horizontal. A pulley zip-line 708 can be connected to a pulley 706, wherein the pulley 706 is configured to be slidable along the zip-line 110. The pulley zip-line 708 can include a swivel 710 to which a toy 712 can be connected for a pet to play. It is to be appreciated that swivel 711 provides rotational motion to the toy 712 attached thereto. Additionally, another swivel 711 can be used to attach the pulley zip-line 708 to the pulley 706 and zip-line 110.

The pet enjoys playing with the toy 712 while the pulley 706 slides along the zip-line 110 for entertainment and movement of the pet. In one alternative embodiment, a dog can be secured to a second pulley zip-line 718 that is connected to a pulley 716, wherein the pulley 716 is configured to be slidable along the zip-line 110. The second pulley zip-line 718 can include a swivel 721 to which a dog's collar can be connected for retaining a pet. It is to be appreciated that swivel 721 provides rotational motion to avoid tangling the pulley zip-line 718 as the dog moves about. Additionally, another swivel 720 can be used to attach the pulley zip-line 718 to pulley 716 and the zip-line 110. The pulley 706 and pulley zip line 708 moves independently from pulley 716 and pulley zip line 718 along zip-line 110.

FIG. 7 illustrates a suction cup connected to a cable for hanging pet toys to keep a pet entertained in accordance with the disclosed architecture. A suction cup 802 can be attached to a surface such as the ceiling 800 of a vehicle or on a roof. A toy 804 can be attached to the a swivel clip 806 present at a terminal end of a clip or cable for allowing the pet to play with the hanging toy 804. It is to be appreciated that the toy 804 can continuously rotate in a 360 degree pivot motion about swivel clip 806. In one embodiment, the suction cup 802 can be attached to a side wall or side surface of a bathtub, thereby enabling the pet to play with waterproof toys 804 while taking a bath.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “autonomous interactive toy kit”, “pet mobile kit”, “toy kit” and “autonomous interactive toy kit for pets” are interchangeable and refer to the pet mobile kit 100 of the present invention.

Notwithstanding the forgoing, the components of the pet mobile kit 100 of the present invention can be of any suitable size and configuration as is known in the art without affecting the overall concept of the invention, provided that it accomplishes the above-stated objectives. One of ordinary skill in the art will appreciate that the size, configuration and material of the components of the pet mobile kit 100 as shown in the FIGS. are for illustrative purposes only, and that many other sizes and shapes of the components of the pet mobile kit 100 are well within the scope of the present disclosure. Although the dimensions of the components of the pet mobile kit 100 are important design parameters for user convenience, the components of the pet mobile kit 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations that fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet toy kit configured to provide autonomous stimulation to a pet, the pet toy kit comprising:
a pet toy stand wherein said stand comprises a weighted stabilizing base;
a vertical sleeve extending from said base;
a U-shaped arm including an upward extending vertical portion, a horizontal portion, and a downward extending vertical portion;
a plurality of mating holes in said sleeve and said upward extending vertical portion for retention of a screw between said mating holes for adjusting the height of said arm;
a mobile clip connected to said downward extending vertical portion for hanging a mobile;
said mobile comprises a circular shape including a plurality of leash clips extending therebelow for hanging a plurality of pet toys to autonomously engage a pet;
each said pet toy hung with a small leash from each one of said leash clips; and
each said leash includes a variable length for hanging said plurality of pet toys at different heights.

2. The pet toy kit of claim 1, wherein said mobile clip is connectable to a wire frame of a dog cage for hanging said mobile inside the dog cage.

3. The pet toy kit of claim 2 further comprising a wireless speaker for providing audio stimulation through a wireless connection source.

4. The pet toy kit of claim 3, wherein said wireless connection source is selected from a group consisting of a Bluetooth connection, an RFID connection, an infrared connection, an NFC connection, and a Wi-Fi connection.

5. The pet toy kit of claim 1, wherein said mobile clip is connectable to a suction cup for mounting to a ceiling.

6. The pet toy kit of claim 5 further comprising a swivel mounted between said suction cup and said pet toy.

7. The pet toy kit of claim 1, wherein said plurality of leash clips are swivel clips.

8. The pet toy kit of claim 1, wherein said mobile clip is a swivel clip.

9. A pet toy kit configured to provide autonomous stimulation to a pet, the pet toy kit comprising:
a pet toy stand wherein said stand comprises a weighted stabilizing base;
a vertical sleeve extending from said base;
a U-shaped arm including an upward extending vertical portion, a horizontal portion, and a downward extending vertical portion;
a plurality of mating holes in said sleeve and said upward extending vertical portion for retention of a screw between said mating holes for adjusting the height of said arm;
a mobile clip connected to said downward extending vertical portion for hanging a mobile;
said mobile comprises a circular shape including a plurality of leash clips extending therebelow for hanging a plurality of pet toys to autonomously engage a pet;
each said pet toy is hung with a small leash from each one of said leash clips;
a wireless speaker for providing audio stimulation through a wireless connection source; and
wherein said wireless connection source is selected from a group consisting of a Bluetooth connection, an RFID connection, an infrared connection, an NFC connection, and a Wi-Fi connection.

10. The pet toy kit of claim 9, wherein each said leash includes a variable length for hanging said plurality of pet toys at different heights.

11. The pet toy kit of claim 9, wherein said mobile clip is connectable to a wire frame of a dog cage for hanging said mobile inside the dog cage.

12. The pet toy kit of claim 9, wherein said mobile clip is connectable to a suction cup for mounting to a ceiling.

13. The pet toy kit of claim 9, wherein said plurality of leash clips are swivel clips.

14. The pet toy kit of claim 9, wherein said mobile clip is a swivel clip.

15. A pet toy kit configured to provide autonomous stimulation to a pet, the pet toy kit comprising:
a pet toy retainer wherein said retainer comprises a pair of stands including a zip-line therebetween;
a first pulley zip-line connected to said zip-line with a first pulley;
said first pulley slidable back and forth along said zip-line;
said first pulley zip-line at a first end includes a first swivel for rotational movement between said first pulley zip-line and said zip line;
said first pulley zip-line at a second end includes a second swivel for rotational movement between said first pulley zip-line and a pet toy connected thereto; and
said pet toy moveable along said zip-line to provide horizontal movement of said pet toy along said zip-line.

16. The pet toy kit of claim 15 further comprising a second pulley zip-line connected to said zip-line with a second pulley, and second pulley slidable back and forth along said zip-line.

17. The pet toy kit of claim 16, wherein said second pulley zip-line at a first end includes a first swivel for rotational movement between said second pulley zip-line and said zip line.

18. The pet toy kit of claim 17, wherein said second pulley zip-line at a second end includes a second swivel for rotational movement between said second pulley zip-line and a pet connected thereto.

19. The pet toy kit of claim 18, said pet moveable along said zip-line to provide horizontal movement of said pet along said zip-line.

20. The pet toy kit of claim 19. wherein said first pulley zip-line and said second pulley zip-line independently movable along said zip-line.
